(19) United States
(12) Patent Application Publication
(10) Pub. No.: US 2010/0190142 A1
(43) Pub. Date: Jul. 29, 2010

(54) DEVICE, SYSTEM, AND METHOD OF AUTOMATIC ASSESSMENT OF PEDAGOGIC PARAMETERS

(75) Inventors: Michael Gal, Herzliya (IL); Tuvia Beker, Givatayim (IL)

Correspondence Address: EITAN MEHULAL LAW GROUP, 10 Abba Eban Blvd. PO Box 2081, Herzlia, 46120, IL

(73) Assignee: TIME TO KNOW LTD.

(21) Appl. No.: 12/360,940

(22) Filed: Jan. 28, 2009

(51) Int. Cl. G09B 3/00

(52) U.S. Cl. 434/322

(57) ABSTRACT

Device, system, and method of automatic assessment of pedagogic parameters. For example, a method of computer-assisted assessment includes: creating a pre-defined ontology of pedagogic concepts; creating a log of interactions of a student with one or more learning activities, wherein the learning activities are concept-tagged based on said ontology; creating a pedagogic Bayesian network based on said log of interactions and based on said ontology; and based on said pedagogic Bayesian network, estimating a pedagogic parameter related to said student.

### FIELD

Some embodiments are related to the field of computer-based teaching and computer-based learning.

### BACKGROUND

Many professionals and service providers utilize computers in their everyday work. For example, engineers, programmers, lawyers, accountants, bankers, architects, physicians, and various other professionals spend several hours a day utilizing a computer. In contrast, many teachers do not utilize computers for everyday teaching. In many schools, teachers use a “chalk and talk” teaching approach, in which the teacher conveys information to students by talking to them and by writing on a blackboard.

### SUMMARY

Some embodiments include, for example, devices, systems, and methods of automatic assessment of pedagogic parameters.

In some embodiments, for example, a method of computer-assisted assessment includes: creating a pre-defined ontology of pedagogic concepts; creating a log of interactions of a student with one or more learning activities, wherein the learning activities are concept-tagged based on said ontology; creating a pedagogic Bayesian network based on said log of interactions and based on said ontology; and based on said pedagogic Bayesian network, estimating a pedagogic parameter related to said student.

In some embodiments, for example, creating the pedagogic Bayesian network includes: determining a set of one or more observable pedagogic variables based on one or more observable task performance items reflected in the log of interactions.

In some embodiments, for example, creating the pedagogic Bayesian network further includes: determining a set of one or more hidden pedagogic variables related to said one or more observable pedagogic variables.

In some embodiments, for example, the hidden pedagogic variables include one or more pedagogic capabilities that the student is required to have in order to successfully accomplish a particular pedagogic task.

In some embodiments, for example, creating the pedagogic Bayesian network further includes: determining one or more dependencies among the one or more hidden pedagogic variables.

In some embodiments, for example, the method includes: creating a set of one or more conditional distribution functions corresponding to an estimation of the probability of possible values for substantially each one of the hidden pedagogic variables.

In some embodiments, for example, the set of one or more conditional distribution functions has at least three possible values corresponding to a strong value, a medium value, and a weak value; and the sum of the probabilities of the three possible values equals to substantially one.

In some embodiments, for example, the method includes: based on analysis of newly-received observable task performance items reflected in the log of interactions, modifying at least one of the probabilities of the possible values of the set of one or more conditional distribution functions.

In some embodiments, for example, the method includes: determining a weighted pedagogic score corresponding to said set of one or more conditional distribution functions, based on the sum of weights of scores corresponding to said possible values.

In some embodiments, for example, the method includes: generating a report indicating pedagogic progress of at least one of: a student, a group of students, and a class of students.

In some embodiments, for example, the method includes: generating an alert indicating a discrepancy between an expected pedagogic parameter of a student and an assessed pedagogic parameter of said student.

In some embodiments, for example, the pedagogic Bayesian network is further based on a teacher input indicating at least one of: a known strength of said student; and a known weakness of said student.

In some embodiments, for example, creating the pedagogic Bayesian network is included within an algorithm which creates one or more statistically evolving models based on relational concept mapping.

In some embodiments, for example, creating the pedagogic Bayesian network comprises creating a dynamic pedagogic Bayesian network; a plurality of copies of the dynamic pedagogic Bayesian network represent a model of said student at a plurality of interconnected time points; and estimating the pedagogic parameter is based on said dynamic pedagogic Bayesian network.

In some embodiments, for example, creating the pedagogic Bayesian network includes creating a hierarchical pedagogic Bayesian network including at least one dependency across two pedagogic domains.

In some embodiments, for example, one or more priors of the pedagogic Bayesian network are dynamically modified based on an analysis which takes into account: metadata of said student, metadata of said one or more learning activities, and activity log of said student.

In some embodiments, for example, the method includes: verifying the pedagogic Bayesian network by at least one of: utilization of controlled simulated student-related data; and utilization of input from a manual assessment process.

In some embodiments, for example, a system for adaptive learning and teaching includes: a repository to store a pre-defined ontology of pedagogic concepts; and a computer-aided assessment module to create a log of interactions of a student with one or more learning activities, wherein the learning activities are concept-tagged based on said ontology; to create a pedagogic Bayesian network based on said log of interactions and based on said ontology; and based on said pedagogic Bayesian network, to estimate a pedagogic parameter related to said student.

In some embodiments, for example, the computer-aided assessment module is to determine a set of one or more observable pedagogic variables based on one or more observable task performance items reflected in the log of interactions.

In some embodiments, for example, the computer-aided assessment module is to determine a set of one or more hidden pedagogic variables related to said one or more observable pedagogic variables.

In some embodiments, for example, the hidden pedagogic variables include one or more pedagogic capabilities that the student is required to have in order to successfully accomplish a particular pedagogic task.

In some embodiments, for example, the computer-aided assessment module is to determine one or more dependencies among the one or more hidden pedagogic variables.

In some embodiments, for example, the computer-aided assessment module is to create a set of one or more conditional distribution functions corresponding to an estimation of the probability of possible values for substantially each one of the hidden pedagogic variables.

In some embodiments, for example, the set of one or more conditional distribution functions has at least three possible values corresponding to a strong value, a medium value, and a weak value; and the sum of the probabilities of the three possible values equals to substantially one.

In some embodiments, for example, based on analysis of newly-received observable task performance items reflected in the log of interactions, the computer-aided assessment module is to modify at least one of the probabilities of the possible values of the set of one or more conditional distribution functions.

In some embodiments, for example, the computer-aided assessment module is to determine a weighted pedagogic score corresponding to said set of one or more conditional distribution functions, based on the sum of weights of scores corresponding to said possible values.

In some embodiments, for example, the system includes: a report generator to generate a report indicating pedagogic progress of at least one of: a student, a group of students, and a class of students.

In some embodiments, for example, the system includes: an alert generator to generate an alert indicating a discrepancy between an expected pedagogic parameter of a student and an assessed pedagogic parameter of said student.

In some embodiments, for example, the pedagogic Bayesian network is further based on a teacher input indicating at least one of: a known strength of said student; and a known weakness of said student.

In some embodiments, for example, the computer-aided assessment module is to create the pedagogic Bayesian network in conjunction with an algorithm which creates one or more statistically evolving models based on relational concept mapping.

In some embodiments, for example, the computer-aided assessment module is to create a dynamic pedagogic Bayesian network; wherein a plurality of copies of the dynamic pedagogic Bayesian network represent a model of said student at a plurality of interconnected time points; and wherein the computer-aided assessment module is to estimate the pedagogic parameter based on said dynamic pedagogic Bayesian network.

In some embodiments, for example, the computer-aided assessment module is to create a hierarchical pedagogic Bayesian network including at least one dependency across two pedagogic domains.

In some embodiments, for example, the computer-aided assessment module is to dynamically modify one or more priors of the pedagogic Bayesian network based on an analysis which takes into account: metadata of said student, metadata of said one or more learning activities, and activity log of said student.

In some embodiments, for example, the computer-aided assessment module is to verify the pedagogic Bayesian network by at least one of: utilization of controlled simulated student-related data; and utilization of input from a manual assessment process.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a teaching/learning system, in accordance with some demonstrative embodiments.

FIGS. 2A-2D are schematic block diagram illustrations of Pedagogic Bayesian Networks (PBNs), in accordance with some demonstrative embodiments.

FIG. 3 is a schematic flow-chart of a method of Computer-Assisted Assessment (CAA), in accordance with some demonstrative embodiments.

FIG. 4 is a schematic block diagram illustration of a PBN system, in accordance with some demonstrative embodiments.

FIG. 5 is a schematic block diagram illustration of a Directed Acy clic Graph (DAG) corresponding to a PBN, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

The term “teacher” as used herein includes, for example, an educator, a tutor, a guide, a principal, a permanent teacher, a substitute teacher, an instructor, a moderator, a supervisor, an adult supervising minors, a parent acting in a role of a teacher, a designated student acting in a role of a teacher, a coach, a trainer, a professor, a lecturer, an education-providing person, a member of an education system, a teaching professional, a teaching person, a member of an education system, a teacher that performs teaching activities in-class and/or out-of-class and/or remotely, a person that conveys information or knowledge to one or more students, or the like.

The term “student” as used herein includes, for example, a pupil, a minor student, an adult student, a scholar, a minor, an adult, a person that attends school on a regular or non-regular basis, a learner, a person acting in a learning role, a learning person, a person that performs learning activities in-class or out-of-class or remotely, a person that receives information or knowledge from a teacher, or the like.

The term “class” as used herein includes, for example, a group of students which may be in a classroom or may not be in the same classroom; a group of students which may be associated with a teaching activity or a learning activity; a group of students which may be spatially separated, over one or more geographical locations; a group of students which may be in-class or out-of-class; a group of students which may include student(s) in class, student(s) learning from their homes, student(s) learning from remote locations (e.g., a remote computing station, a library, a portable computer), or the like.

Some embodiments may be used in conjunction with one or more components, devices, systems and/or methods described in U.S. patent application Ser. No. 11/831,981, titled “Device, System, and Method of Adaptive Teaching and Learning”, filed on Aug. 1, 2007, which is hereby incorporated by reference in its entirety.

Although portions of the discussion herein may relate, for demonstrative purposes, to a Bayesian Network or to a Pedagogic Bayesian Network (PBN), some embodiments may utilize other types of models or networks, statistically evolving models, models based on relational concept mapping, models for estimation of hidden variables based on observable variables, or the like.

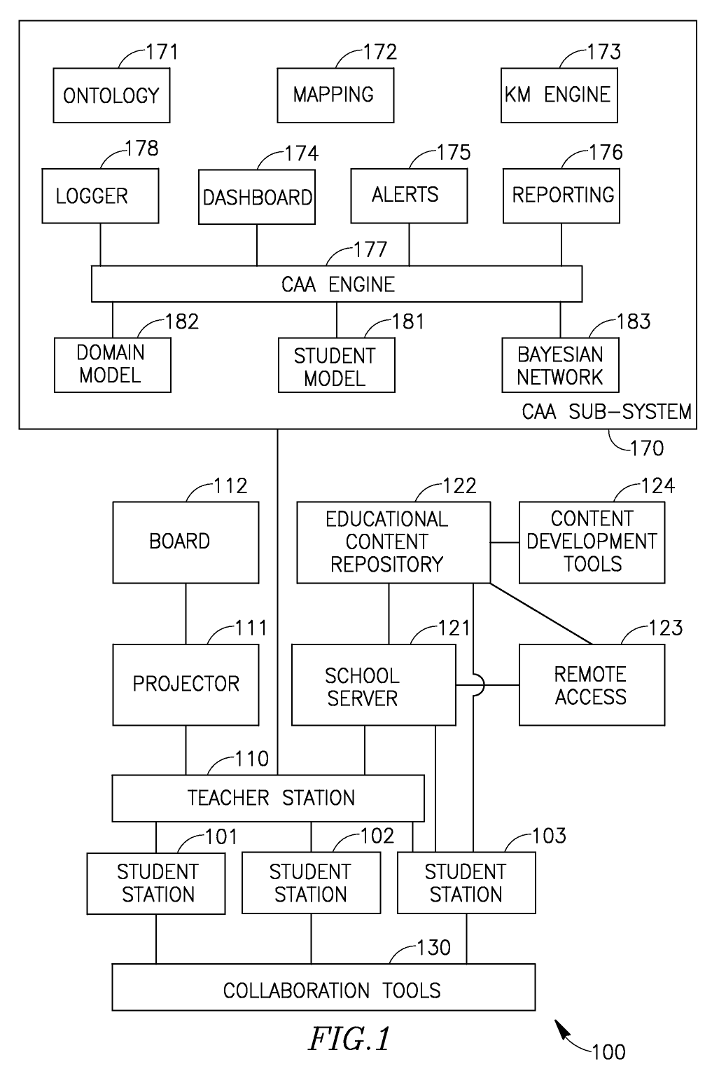

FIG. 1 is a schematic block diagram illustration of a teaching/learning system 100 in accordance with some demonstrative embodiments. Components of system 100 are interconnected using one or more wired and/or wireless links, e.g., utilizing a wired LAN, a wireless LAN, the Internet, and/or other communication systems.

System 100 includes a teacher station 110, and multiple student stations 101-103. The teacher station 110 and/or the student stations 101-103 may include, for example, a desktop computer, a Personal Computer (PC), a laptop computer, a mobile computer, a notebook computer, a tablet computer, a portable computer, a dedicated computing device, a general purpose computing device, a cellular device, or the like.

The teacher station 110 and/or the student stations 101-103 may include, for example: a processor (e.g., a Central Processing Unit (CPU), a Digital Signal Processor (DSP), a microprocessor, a host processor, a controller, a plurality of processors or controllers, a chip, a microchip, one or more circuits, circuitry, a logic unit, an Integrated Circuit (IC), an Application Specific IC (ASIC), or any other suitable multi-purpose or specific processor or controller); an input unit (e.g., a keyboard, a keypad, a mouse, a touch-pad, a stylus, a microphone, or other suitable pointing device or input device); an output unit (e.g., a Cathode Ray Tube (CRT) monitor or display unit, a Liquid Crystal Display (LCD) monitor or display unit, a plasma monitor or display unit, a screen, a monitor, one or more speakers, or other suitable display unit or output device); a memory unit (e.g., a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units); a storage unit (e.g., a hard disk drive, a floppy disk drive, a Compact Disk (CD) drive, a CD-ROM drive, a Digital Versatile Disk (DVD) drive, or other suitable removable or non-removable storage units); a communication unit (e.g., a wired or wireless Network Interface Card (NIC) or network, adapter, a wired or wireless modem, a wired or wireless receiver and/or transmitter, a wired or wireless transmitter-receiver or transceiver, a Radio Frequency (RF) communication unit or transceiver, or other units able to transmit and/or receive signals, blocks, frames, transmission streams, packets, messages and/or data; the communication unit may optionally include, or may optionally be associated with, one or more antennas or sets an antennas; an Operating System (OS); and other suitable hardware components and/or software components.

The teacher station 110, optionally utilizing a projector 111 and a board 112, may be used by the teacher to present educational subject matters and topics, to present lectures, to convey educational information to students, to perform lesson planning, to perform in-class lesson execution and management, to perform lesson follow-up activities or processes (e.g., review students performance, review homework, review quizzes, or the like), to assign learning activities to one or more students (e.g., on a personal basis and/or on a group basis), to conduct discussions, to assign homework, to obtain the personal attention of a student or a group of student, to perform real-time in-class teaching, to perform real-time in-class management of the learning activities performed by students or groups of students, to selectively allocate or re-allocate learning activities or learning objects to students or groups of students, to receive automated feedback or manual feedback from student stations 101-103 (e.g., upon completion of a learning activity or a learning object; upon reaching a particular grade or success rate; upon failing to reach a particular grade or success rate; upon spending a threshold amount of attempts or minutes with a particular exercise, or the like), or to perform other teaching and/or class management operations.

In some embodiments, the teacher station 110 may be used to perform operations of teaching tools, for example, lesson planning, real-time class management, presentation of educational content, allocation of differential assignment of content to students (e.g., to individual students or to groups of students), differential assignment of learning activities or learning objects to students (e.g., to individual students or to groups of students), adaptive assignment of content or learning activities or learning objects to students (e.g., based on their past performance in one or more learning activities, past successes, past failures, identified strengths, identified weaknesses), conducting of class discussions, monitoring and assessment of individual students or one or more groups of students, logging and/or reporting of operation performed by students and/or achievements of students, operating of a Learning Management System (LMS), managing of multiple learning processes performed (e.g., substantially in parallel or substantially simultaneously) by student stations 101-103, or the like. In some embodiments, some operations (e.g., logging operations) may be performed by a server (e.g., LMS server) or by other units external to the teacher station 110, whereas other operations (e.g., reporting operations) may be performed by the teacher station 110.

The teacher station 110 may be used in substantially real time (namely, during class hours and while the teacher and the students are in the classroom), as well as before and after class hours. For example, real time utilization of the teacher station includes: presenting topics and subjects; assigning to students various activities and assignments; conducting discussions; concluding the lesson; and assigning homework. Before and after class hours utilization include, for example: selecting and allocating educational content (e.g., learning objects or learning activities) for a lesson plan; guiding students; assisting students; responding to students questions; assessing work and/or homework of students; managing differential groups of students; and reporting.

The student stations 101-103 are used by students (e.g., individually such that each student operates a station, or that two students operate a station, or the like) to perform personal learning activities, to conduct personal assignments, to participate in learning activities in-class, to participate in assessment activities, to access rich digital content in various educational subject matters in accordance with the lesson plan, to collaborate in group assignments, to participate in discussions, to perform exercises, to participate in a learning community, to communicate with the teacher station 110 or with other student stations 101-103, to receive or perform personalized learning activities, or the like. In some embodiments, the student stations 101-103 may optionally include or utilize software components which may be accessed remotely by the student, for example, to allow the student to do homework from his home computer using remote access, to allow the student to perform learning activities or learning objects from his home computer or from a library computer using remote access, or the like. In some embodiments, student stations 101-103 may be implemented as “thin” client devices, for example, utilizing an Operating System (OS) and a Web browser to access remotely-stored educational content (e.g., through the Internet, an Intranet, or other types of networks) which may be stored on external and/or remote server(s).

The teacher station 110 is connected to, or includes, the projector 111 able to project or otherwise display information on a board 112, e.g., a blackboard, a white board, a curtain, a smart-board, or the like. The teacher station 110 and/or the projector 111 may be used by the teacher, to selectively project or otherwise display content on the board 112. For example, at first, a first content is presented on the board 112, e.g., while the teacher talks to the students to explain an educational subject matter. Then, the teacher may utilize the teacher station 110 and/or the projector 111 to stop projecting the first content, while the students use their student stations 101-103 to perform learning activities. Additionally, the teacher may utilize the teacher station 110 and/or the projector 111 to selectively interrupt the utilization of student stations 101-103 by students. For example, the teacher may instruct the teacher station 110 to send an instruction to each one of student stations 101-103, to stop or pause the learning activity and to display a message such as “Please look at the Board right now” on the student stations 101-103. Other suitable operations and control schemes may be used to allow the teacher station 110 to selectively command the operation of projector 111 and/or board 112.

The teacher station 110, as well as the student stations 101-103, may be connected with a school server 121 able to provide or serve digital content, for example, learning objects, learning activities and/or lessons. Additionally or alternatively, the teacher station 110, as well as the student stations 101-103, may be connected to an educational content repository 122, either directly (e.g., if the educational content repository 122 is part of the school server 121 or associated therewith) or indirectly (e.g., if the educational content repository 122 is implemented using a remote server, using Internet resources, or the like). In some embodiments, system 100 may be implemented such that educational content are stored locally at the school, or in a remote location. For example, a school server may provide full services to the teacher station 110 and/or the student stations 101-103; and/or, the school server may operate as mediator or proxy to a remote server able to serve educational content.

Content development tools 124 may be used, locally or remotely, to generate original or new education content, or to modify or edit or update content items, for example, utilizing templates, editors, step-by-step “wizard” generators, packaging tools, sequencing tools, “wrapping” tools, authoring tools, or the like.

In some embodiments, a remote access sub-system 123 is used, to allow teachers and/or students to utilize remote computing devices (e.g., at home, at a library, or the like) in conjunction with the school server 121 and/or the educational content repository 122.

In some embodiments, the teacher station 110 and the student stations 101-103 may be implemented using a common interface or an integrated platform (e.g., an “educational workstation”), such that a log-in screen request the user to select or otherwise input his role (e.g., teacher or student) and/or identity (e.g., name or unique identifier).

In some embodiments, system 100 performs ongoing assessment of students performance based on their operation of student stations 101-103. For example, instead of or in addition to conventional event-based quizzes or examinations, system 100 monitors the successes and the failures of individual students in individual learning objects or learning activities. For example, the teacher utilizes the teacher station 110 to allocate or distribute various learning activities or learning objects to various students or groups of students. The teacher utilizes the teacher station 110 to allocate a first learning object and a second learning object to a first group of students, including Student A who utilizes student station 101; and the teacher utilizes the teacher station 110 to allocate the first learning object and a third learning object to a second group of students, including Student B who utilizes student station 102.

System 100 monitors, logs and reports the performance of students based on their operation of student stations 101-103. For example, system 100 may determine and report that Student A successfully completed the first learning object, whereas Student B failed to complete the second learning object. System 100 may determine and report that Student A successfully completed the first learning object within a pre-defined time period associated with the first learning object, whereas Student B completed the second learning object within a time period longer than the required time period. System 100 may determine and report that Student A successfully completed or answered 87 percent of tasks or questions in a learning object or a learning activity, whereas Student B successfully completed or answered 45 percent of tasks or questions in a learning object or a learning activity. System 100 may determine and report that Student A successfully completed or answered 80 percent of the tasks or questions in a learning object or a learning activity on his first attempt and 20 percent of tasks or questions only on the second attempt, whereas Student B successfully completed or answered only 29 percent on the first attempt, 31 percent on the second attempt, and for the remaining 40 percent he got the right answer from the student station (e.g., after providing incorrect answers on three attempts). System 100 may determine and report that Student A appears to be “stuck” or lingering on a particular exercise or learning object, or that Student B did not operate the keyboard or mouse for a particular time period (e.g., two minutes). System 100 may determine and report that at least 80 percent of the students in the first group successfully completed at least 75 percent of their allocated learning activity, or that at least 50 percent of the students in the second group failed to correctly answer at least 30 percent of questions allocated to them. Other types of determinations and reports may be used.

System 100 generates reports at various times and using various methods, for example, based on the choice of the teacher utilizing the teacher station 110. For example, the teacher station 110 may generate one or more types of reports, e.g., individual student reports, group reports, class reports, an alert-type message that alerts the teacher to a particular event (e.g., failure or success of a student or a group of students), or the like. Reports may be generated, for example, at the end of a lesson; at particular times (e.g., at a certain hour); at pre-defined time intervals (e.g., every ten minutes, every school-day, every week); upon demand, request or command of a teacher utilizing the teacher station; upon a triggering event or when one or more conditions are met, e.g., upon completion of a certain learning activity by a student or group of students, a student failing a learning activity, a pre-defined percentage of students failing a learning activity, a student succeeding in a learning activity, a pre-defined percentage of students succeeding in a learning activity, or the like.

In some embodiments, reports or alerts may be generated by system 100 substantially in real-time, during the lesson process in class. For example, system 100 may alert the teacher, using a graphical or textual or audible notification through the teacher station 110, that one or more students or groups of students do not progress (at all, or according to pre-defined mile-stones) in the learning activity or learning object assigned to them. Upon receiving the real-time alert, the teacher may utilize the teacher station 110 to further retrieve details of the actual progress, for example, by obtaining detailed information on the progress of the relevant student(s) or group(s). For example, the teacher may use the teacher station 110 to view a report detailing progress status of students, e.g., whether the student started or not yet started a learning object or a learning activity; the percentage of students in the class or in one or more groups that completed as assignment; the progress of students in a learning object or a learning activity (e.g., the student performed 40 percent of the learning activity; the student is “stuck” for more than three minutes in front of the third question or the fourth screen of a learning object; the student completed the assigned learning object, and started to perform an optional learning object), or the like.

In some embodiments, teaching, learning and/or assessment activities are monitored, recorded and stored in a format that allows subsequent searching, querying and retrieval. Data mining processes in combination with reporting tools may perform research and may generate reports on various educational, pedagogic and administrative entities, for example: on students (single student, a group of students, all students in a class, a grade, a school, or the like); teachers (a single teacher, a group of teachers that teach the same grade and/or in the same school and/or the same discipline); learning activities and related content; and for conducting research and formative assessment for improvement of teaching methodologies, flow or sequence of learning activities, or the like.

In some embodiments, data mining processes and analysis processes may be performed, for example, on knowledge maps of students, on the tracked and logged operations that students perform on student stations, on the tracked and logged operations that teachers perform on teacher stations, or the like. The data mining and analysis may determine conclusions with regard to the performance, the achievements, the strengths, the weaknesses, the behavior and/or other properties of one or more students, teachers, classes, groups, schools, school districts, national education systems, multi-national or international education systems, or the like. In some embodiments, analysis results may be used to compare among teaching and/or learning at international level, national level, district level, school level, grade level, class level, group level, student level, or the like.

In some embodiments, the generated repots are used as alternative or additional assessment of students performance, students knowledge, students learning strategies (e.g., a student is always attempting trial and error when answering; a student is always asking the system for the hint option), students classroom behavior (e.g., a student is responsive to instructions, a student is non-responsive to instructions), or other student parameters. In some embodiments, for some assessment events, information items (e.g., “rubrics”) may be created and/or displayed, to provide assessment-related information to the teacher or to the teaching/learning system; the assessment information item may be visible to, or accessible by, the teacher and/or the student (e.g., subject to teacher's authorization). The assessment information item may include, for example, a built-in or integrated information item inside an assessment event that provides instructions to the teacher (or the teaching/learning system) on how to evaluate an assessment event which was executed by the student. Other formats and/or functions of assessment information items may be used.

Optionally, system 100 generates and/or initiates, automatically or upon demand of the teacher utilizing the teacher station 110 (or, for example, automatically and subject to the approval of the teacher utilizing the teacher station 110), one or more student-adapted correction cycles, “drilling” cycles, additional learning objects, modified learning objects, or the like. In view of data from of the students' record of performance, system 100 may identify strengths and weaknesses, comprehension and misconceptions. For example, system 100 determines that Student A solved correctly 72 percent of the math questions presented to him; that substantially all (or most of) the math questions that Student A solved successfully are in the field of multiplication; and that substantially all (or most of) the math questions that Student A failed to solved are in the field of division. Accordingly, system 100 may report to the teacher station 110 that Student A comprehends multiplication, and that Student A does not comprehend (at all, or to an estimated degree) division. Additionally, system 100 adaptively and selectively presents content (or refrain from presenting content) to accommodate the identified strengths and weaknesses of Student A. For example, system 100 may selectively refrain from presenting to Student A additional content (e.g., hints, explanations and/or exercises) in the field of multiplication, which Student A comprehends. System 100 may selectively present to Student A additional content (e.g., explanations, examples and/or exercises) in the field of division, which Student B does not yet comprehend. The additional presentation (or the refraining from additional presentation) may be performed by system 100 automatically, or subject to an approval of the teacher utilizing the teacher station 110 in response to an alert message or a suggestion message presented on the teacher station 110.

In some embodiments, if given the appropriate permission(s), multiple types of users may utilize system 100 or its components, in-class and/or remotely. Such types of users include, for example, teachers in class, students in class, teachers at home or remotely, students at home or remotely, parents, community members, supervisors, managers, principals, authorities (e.g., Board of Education), school system administrator, school support and help-desk personnel, system manager(s), techno-pedagogic experts, content development experts, or the like.

In some embodiments, system 100 may be used as a collaborative Learning Management System (LMS), in which teachers and students utilize a common system. For example, system 100 may include collaboration tools 130 to allow real-time in-class collaboration, e.g., allowing students to send or submit their accomplishments or their work results (or portions thereof) to a common space, from which the teacher (utilizing the teacher station 110) selects one or more of the submission items for projection, for comparison, or the like. The collaboration tools 130 may optionally be implemented, for example, using a collaboration environment or collaboration area or collaboration system. The collaboration tools 130 may optionally include a teacher-moderated common space, to which students (utilizing the student stations 101-103) post their work, text, graphics, or other information, thereby creating a common collaborative “blog” or publishing a Web news bulletin or other form of presentation of students products. The collaboration tools 130 may further provide a collaborative workspace, where students may work together on a common assignment, optionally displaying in real-time peers that are available online for chat or instant messaging (e.g., represented using real-life names, user-names, avatars, graphical items, textual items, photographs, links, or the like).

In some embodiments, dynamic personalization and/or differentiation may be used by system 100, for example, per teacher, per student, per group of students, per class, per grade, or the like. System 100 and/or its educational content may be open to third-party content, may comply with various standards (e.g., World Wide Web standards, education standards, or the like). System 100 may be a tagged-content Learning Content Management System (LCMS), utilizing Semantic Web mechanisms, meta-data, tagging content and learning activities by concept-based controlled vocabulary, describing their relations to educational and/or disciplinary concepts, and/or democratic tagging of educational content by users (e.g., teachers, students, experts, parents, or the like).

System 100 may utilize or may include pluggable architecture, for example, a plug-in or converter or importer mechanism, e.g., to allow importing of external materials or content into the system as learning objects or learning activities or lessons, to allow smart retrieval from the content repository, to allow identification by the LMS system and the CAA sub-system, to allow rapid adaptation of new types of learning objects (e.g., original or third-party), to provide a blueprint or a template for third-party content, or the like.

System 100 may be implemented or adapted to meet specific requirements of an education system or a school. For example, in some embodiments, system 100 may set a maximum number of activities per sequence or per lesson; may set a maximum number of parallel activities that the teacher may allocate to students (e.g., to avoid a situation in which the teacher “loses control” of what each student in the class is doing); may allow flexible navigation within and/or between learning activities and/or learning objects; may include clear, legible and non-artistic interface components, for easier or faster comprehension by users; may allow collaborative discussions among students (or student stations), and/or among one or more students (or student stations) and the teacher (or teacher station); and may train and prepare teacher and students for using the system 100 and for maximizing the benefits from its educational content and tools.

In some embodiments, a student station 101-103 allows the student to access a “user cabinet” or “personal folder” which includes personal information and content associated with that particular student. For example, the “user cabinet” may store and/or present to the student: educational content that the student already viewed or practiced; projects that the student already completed and/or submitted; drafts and work-in-progress that the student prepares, prior to their completion and/or submission; personal records of the student, for example, his grades and his attendance records; copies of tests or assignments that the student already took, optionally reconstructing the test or allowing the test to be re-solved by the student, or optionally showing the correct answers to the test questions; lessons that the student already viewed; tutorials that the student already viewed, or tutorials related to topics that the student already practiced; forward-looking tutorials, lectures and explanations related to topics that the student did not yet learn and/or did not yet practice, but that the student is required to learn by himself or out of class; assignments or homework assignments pending for completion; assignments or homework assignments completed, submitted, graded, and/or still in draft status; a notepad with private or personal notes that the student may write for his retrieval; indications of “bookmarks” or “favorites” or other pointers to learning objects or learning activities or educational content which the student selected to mark as favorite or for rapid access; or the like.

In some embodiments, the teacher station 110 allows the teacher (and optionally one or more students, if given appropriate permission(s), via the student stations) to access a “teacher cabinet” or “personal folder” (or a subset thereof, or a presentation or a display of portions thereof), which may, for example, store and/or present to the teacher (and/or to students) the “plans” or “activity layout” that the teacher planned for his class; changes or additions that the teacher introduced to the original plan; presentation of the actually executed lesson process, optionally including comments that the teacher entered; or the like.

System 100 may utilize Computer-Assisted Assessment or Computer-Aided Assessment (CAA) of performance of student(s) and of pedagogic parameters related to student(s). In some embodiments, for example, system 100 may include, or may be coupled to, a CAA sub-system 170 having multiple components or modules, e.g., components 171-177. In some embodiments, CAA sub-system 170 may be an add-on to system 100, or to other techno-pedagogic or educational systems, in which the CAA sub-system 170 is given access to a database storing students' assessment data (e.g., automated assessment using a computerized system, or manual assessment as assessed and noted by teachers).

An ontology component 171 includes a concept-based controlled vocabulary (expressed using one or more languages) encompassing the system's terminological knowledge, reflecting the explicit and implicit knowledge present within the system's learning objects. The ontology component 171 may be implemented, for example, as a relational database including tables of concepts and their definitions, terms (e.g., in one or more languages), mappings from terms to concepts, and relationships across concepts. Concepts may include educational objectives, required learning outcomes or standards and milestones to be achieved, items from a revised Bloom Taxonomy, models of cognitive processes, levels of learning activities, complexity of gained competencies, general and subject-specific topics, or the like. The concepts of ontology 171 may be used as the outcomes for CAA and/or for other applications, for example, planning, search/retrieval, differential lesson generation, or the like.

A mapping and tagging component 172 indicates mapping between the various learning objects or learning entities (e.g., stored in the educational content repository 122) to the ontology concepts (e.g., knowledge elements) reflecting the pedagogic values of these learning entities. The mapping may be, for example, one-to-one or one-to-many. The mapping may be performed based on input from discipline-specific assessment experts.

A knowledge map engine 173 receives multiple types of inputs: information about the activities of the student (e.g., answers to questions, the difficulty level of each question, the time it took to complete various tasks, the location where different tasks were performed); the mappings between the activities performed by the student and the knowledge elements that these activities contribute to; and a model (e.g., a “required knowledge map”) of the knowledge elements and capabilities that the student is expected to master within a given learning unit, including the possible relationships between such elements. The knowledge map engine 173 utilizes these inputs to establish an “acquired knowledge map” estimating, at any given point in time, the degree to which the student mastered each of the required knowledge elements or capabilities. The knowledge map engine 173 may use graphical models of belief propagation to build a model of the knowledge map of the student, and may update this model over time, as information about more activities performed by the student becomes available.

The knowledge map engine 173 may perform and/or allow, for example: a way to glean and incorporate expert knowledge into the system, in the form of prior probabilities and relationships between properties to be assessed; the relationships between observed learning outcomes and related competencies or skills; assessment of properties that are not directly observable; multi-dimensional assessment; a natural measure of assessment accuracy, given by the standard deviation of the distribution function for each assessed variable; and ability to detect the most probable causes for student deficient performance. Furthermore, with time and the accumulation of information about student activities, the model becomes more and more accurate at assessing the student's knowledge. The model may, over time, serve as an accurate tool for assigning grades to the students knowledge and learning abilities, as well as directing the course of learning, for example, by finding areas where the student needs additional help in form of explanations, training, exercising, or the like.

A dashboard component 174 may include a customizable interface used as a base for providing CAA. The dashboard 174 uses data mining algorithms to allow a comprehensive view of students activities, teachers activities and classes activities, as well as skills and achievements; including the ability to drill down for a detailed view of every entity in the system. The dashboard 174 may be used by teachers, students, principals, and parents, and may be tailored to serve the specific needs of its different users. The dashboard 174 may be used to display information via graphs, alerts, and reports. In some embodiments, the dashboard 174 may be implemented as part of the teacher station 110, as part of a student station 101-103, as a component available to remote users via the remote access sub-system 123, as a stand-alone component, or the like.

An alerts engine 175 includes a customizable alert generator able to notify the teacher's station 110 of extreme student assessment-related behavior, or of student assessment-related behavior that meets pre-defined criteria or is above or below pre-defined threshold values. In some embodiments, the alerts may be viewed directly from the dashboard 174, and may be linked to relevant reports.

A reporting engine 176 includes a customizable reporting system used for providing user-specific detailed assessment-related information. The reports may be accessed directly via the dashboard 174 and/or by drilling down into specific alerts.

A CAA engine 177 may build and update a student model 181 in order to track a student's knowledge and capabilities relative to a domain model 182, namely, a specification of required or desired knowledge and capabilities within a given domain. The CAA engine 177 may receive as input multiple types of data: the required or desired knowledge map; mapping of tasks performed by the student to knowledge and capabilities represented in the knowledge map; information about the performed tasks, for example, task parameters (e.g., type, difficulty level) and performance metrics (e.g., correct or incorrect answer, number of attempts, time spent on task).

In some embodiments, the required or desired knowledge map may be a proper subset of concepts from the ontology 171 representing the different elements of knowledge (e.g., facts, capabilities, or the like) relevant to a given domain. The domain may be, for example, a subject taught in a particular grade within a particular school system. The ontology 171 may include, for example, a concept-based multilingual controlled vocabulary covering concepts relevant to a pedagogic system, as well as their concomitant terms and relationships across concepts. Concepts may include, for example: curricular concepts; concepts derived from a required “official” curriculum or syllabus; outcome concepts, reflecting concepts used for tagging atoms within the system's learning objects and linked to curricular concepts; and components of fine granularity which combine to form outcome concepts.

The CAA engine 177 may maintain and update the student model 181 as a Pedagogic Bayesian Network (PBN) 183, for example, an algorithmic construct that allows estimation of and inference about multiple random (or pseudo-random) variables having multiple dependencies.

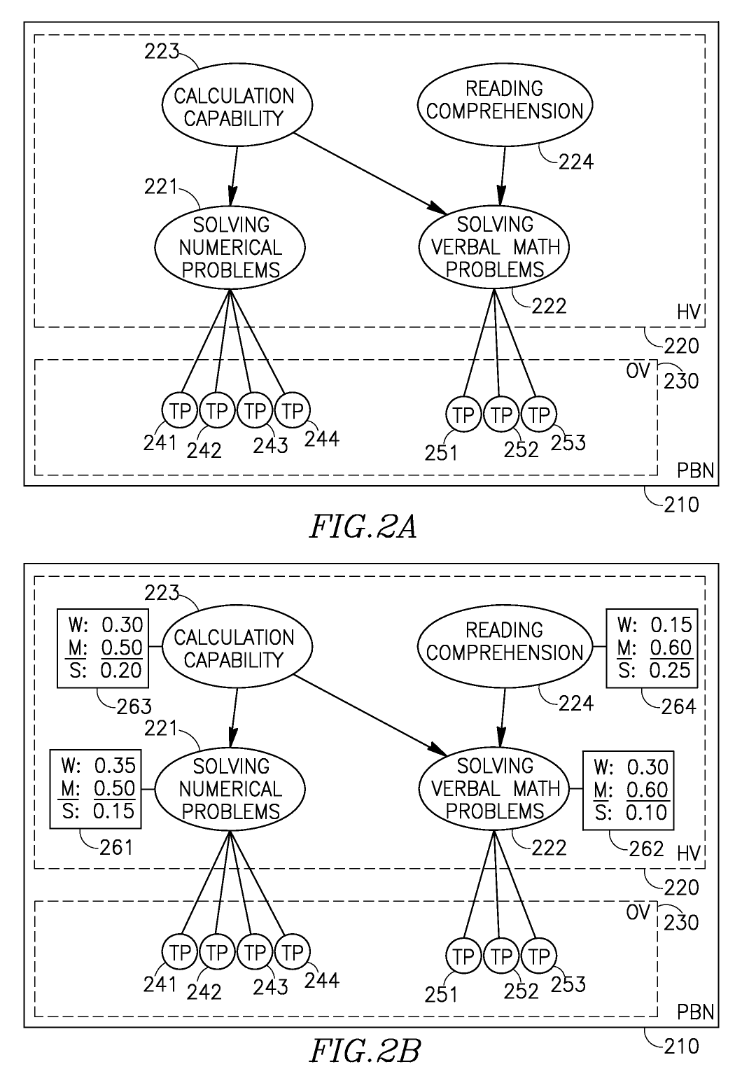

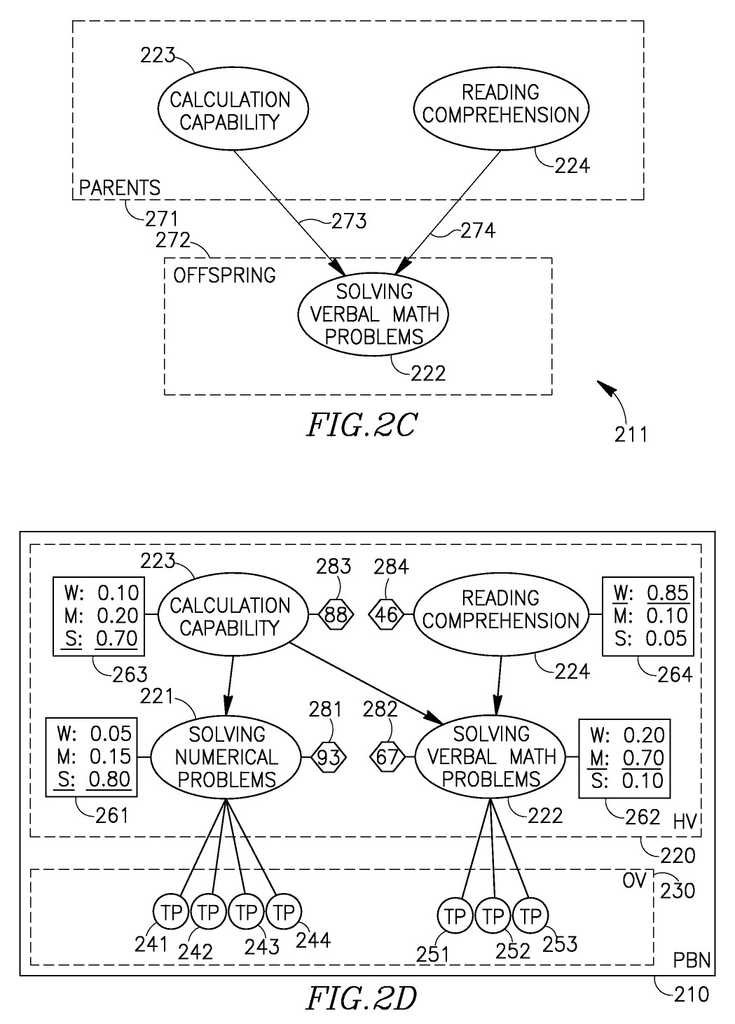

For example, in the student model 181, hidden variables may correspond to knowledge elements, capabilities, or similar variables which are to be assessed. The student model 181 may further accommodate variables corresponding to higher-level entities, for example, cognitive state of the student (e.g., alertness or boredom). Observable variables in the student model 181 may correspond, for example, to information about performed tasks. Reference is made to FIGS. 2A-2D, which are schematic block diagram illustrations of Pedagogic Bayesian Networks (PBNs) utilized in some embodiments, for example, by the CAA engine 177 of FIG. 1, in the student model 181 of FIG. 1, or the like.

As demonstrated in FIG. 2A, a PBN 210 may include a set of one or more Hidden Variables (HV) 220 and a set of one or more Observable Variables (OV) 230. For example, in the domain of mathematics, a student may be perform a task including one or more numerical problems presented to her, thereby producing a set of one or more observable results, namely, Task Performance (TP) items 241-244. Similarly, the student may be perform another task including one or more verbal mathematical problems presented to her, thereby producing another set of one or more observable results, namely, Task Performance (TP) items 251-253.

The observable TP items 241-244 are the observable result of the student's hidden capability of solving numerical problems, represented as a hidden variable 221. Similarly, the observable TP items 251-253 are the observable result of the student's hidden capability of solving verbal mathematical problems, represented as a hidden variable 222.

Furthermore, within the set of Hidden Variables 220, the student's capability of solving numerical problems hidden variable 221) is dependent on the student's calculation capability (hidden variable 223); whereas the student's capability of solving verbal mathematical problems (hidden variable 222) is dependent on both the student's calculation capability (hidden variable 223) and the student's reading comprehension capability (hidden variable 224). These dependencies may be based, for example, on a determination or an assumption, that in order to correctly solve a purely numerical problem, only a calculation capability is required; whereas, in order to correctly solve a verbal mathematical problem, both a reading comprehension capability and a calculation capability are required. The CAA engine 177 may utilize the PBN 210 in order to determine, for example, whether an imperfect performance of the student in solving verbal mathematical problems, as reflected in the observable Task Performance items 251-253, is more probably a result of deficiency in calculation capability, deficiency in reading comprehension capability, or deficiencies in both calculation capability and reading comprehension capabilities.

The state of a variable in the PBN 210 (which is included in or used by, for example, student model 181) may be a distribution function describing the knowledge or estimation of the system (e.g., of the CAA engine 177) about the probability of each possible value for that variable. In a demonstrative example, each one of the four hidden variables 221-224 may have three possible values: “weak”, “medium”, or “strong”, corresponding to the level of mastering by the student of this capability or knowledge item. Accordingly, the the state of each one of the hidden variables 221-224 may be described by a triple-valued probability distribution function, whose three values sum to 1. This is demonstrated in FIG. 2B, in which triple-valued probability distribution functions 261-264 are shown, corresponding to hidden variables 221-224. In each one of the probability distribution functions 261-264, the most likely value for each hidden variable is underlined, and its corresponding probability value is similarly highlighted.

In some embodiments, the PBN 210 may reflect information about conditional independence between variables; and arrows in the PBN 210 may represent a parenthood/offspring relation between variables. For example, as demonstrated in FIG. 2C, a parents/offspring diagram 211 includes a set 271 of one or more parent entities and a set 272 of one or more offspring entities. In a demonstrative example corresponding to the PBN 210 of FIGS. 2A-2B, the parent set 271 includes two entities, namely, the calculation capability 223 and the reading comprehension capability 224; whereas the offspring set 272 includes one entity, namely, solving verbal mathematical problems 222. As indicated by arrows 273 and 274, the offspring capability of solving verbal mathematical problems 222 is dependent on both parent capabilities, namely, the calculation capability 223 and the reading comprehension capability 224.

In some embodiments, given the states of all parents of a particular node (e.g., a particular hidden variable), the state of that particular node (e.g., hidden variable) is independent of any other nodes in the PBN 210. Accordingly, in some embodiments, the state of a variable in the PBN 210 is the conditional probability distribution of this variable, given the states of its parent nodes.

Before the system begins to update the student model 181 based on task performance observations, the student model 181 is initialized with one or more prior probabilities about the states of the various variables and the conditional probabilities between them. In some embodiments, such priors may be determined based on input from domain experts. Once some aggregate data is obtained about a student population, the priors may be refined through estimates of the probability distributions in the population and/or subgroups thereof. The system is capable of continuously “learning”, and the more information is gathered in the system about students' activities and their achievements, the greater the accuracy of the predictions, estimations and assessments generated by the system.

In some embodiments, more accurate priors may be set by teachers utilizing specific knowledge about the capabilities of the student, or by the students themselves. For example, the teacher may utilize the teacher station 110 to enter into system 100 a specific indication that Student A is proficient or strong in multiplication, thereby aiding the system 100 to turn one of the hidden variables into a known variable. The student model 181 may be robust to inaccuracy in determining the prior probabilities, as their value is eventually overridden by updates derived from actual student performance. However, setting appropriate priors may allow faster convergence of the student model 181 and earlier attainment of accurate assessment.

Once information becomes available about the performance of the student in learning tasks, this information may be used to update the estimate about the states of the various variables in the PBN 210. In some embodiments, student model may be separate from evidence model, or the two models may be treated as a single network. In some embodiments, the architecture of the PBN 210 (e.g., conditional independence or parenthood relationships) may be provided by domain experts, and/or utilizing one or more algorithms which may update and refine this architecture based on observed data.

In some embodiments, information about the performance of the student may be available from a variety of information sources, for example: the performance gathered by the system 100 from the student interaction with the educational content in the educational content repository 122; information imported from other assessment systems (e.g., a third-party or external test generator or electronic testing system); information that the teacher enters manually based on her observations and/or her personal assessment of “open” assignments (e.g., assays, science projects, oral presentations, or the like). In some embodiments, the system 100 may require that these resources of information are mapped and/or tagged with the concepts of the ontology 171.

For a given learning task, the parameters of the task determine how to modify the estimate regarding the variables that are directly related to this task. For example, if a student fails in a task, it would have a negative effect on the estimation of the value of a parent variable that is important for fulfilling that task. However, this negative effect may be smaller if the task is classified as a difficult task than if the task is classified as an easy task. Similarly, success in a difficult task may have a larger impact in strengthening the estimation that the student masters a capability that this task depends on. Similar rules may be applied to other properties of the task. In some embodiments, for example, rules may relate to repetitive success over time: success after a long period of time that passed since the skill was learned may show a larger impact than success immediately after the teacher's demonstration.

The effect of observations on task performance may not be limited to the variables which are directly related to that task performance. Algorithms for updating the PBN 210 may propagate this effect to other variables in PBN 210. For example, the probability distributions 261-264 may correspond to the marginal prior probabilities of the four hidden variables 221-224, respectively. According to the prior estimate shown in FIG. 2B, each one of the hidden variables 221-224 is most likely to be at the proximity of the “medium” level. However, referring now to FIG. 2D, information gathered from multiple tasks (e.g., the observable Task Performance (TP) items 241-244 and 251-253) may result an increase in the estimation that the student knows how to solve numerical problems, but may decrease the estimation that the student knows how to solve verbal problems. As shown in FIG. 2D, the probability distributions 261-264 changed, such that hidden variable 221 is most likely to have a “strong” value; hidden variable 222 is most likely to still have a “medium” value (although at a slightly smaller probability); hidden variable 223 is most likely to have a “strong” value; and hidden variable 224 is most likely to have a “weak” value. Accordingly, the estimation about the student's underlying calculation capability increases, but the estimation about the student's reading comprehension ability decreases.

In some embodiments, the state of the PBN 210 may be converted or translated into a set of scores corresponding to each of the underlying variables. For example, numerical values may be assigned to each of the values that the variables may take, and then the expectation may be calculated for each variable. In the demonstrative example shown in FIG. 2D, a score of “40” may correspond to a value of “weak”, a score of “70” may correspond to a value of “medium”, and a score of “100” may correspond to a value of “strong”. Accordingly, the marginal probability distributions 261-264 may be converted into estimated scores 281-284, respectively, as shown in FIG. 2D.

In some embodiments, the representation of assessment values as probability distributions may be more informative than a single scalar score per variable. For example, two probability distributions are shown in Tables 1 and 2.

TABLE 1

| RANK | PROBABILITY | VALUE | WEIGHT |
|---|---|---|---|
| Weak | 0.05 | 40 | 2 |
| Medium | 0.90 | 70 | 63 |
| Strong | 0.05 | 100 | 5 |
| | | SCORE: | 70 |

TABLE 2

| RANK | PROBABILITY | VALUE | WEIGHT |
|---|---|---|---|
| Weak | 0.30 | 40 | 12 |
| Medium | 0.40 | 70 | 28 |
| Strong | 0.30 | 100 | 30 |
| | | SCORE: | 70 |

In both cases, the score is the same, namely, “70”. However, in the case shown in Table 1, the probability distribution is concentrated on the “medium” value, with low probability for the two other values. In contrast, in the case shown in Table 2, the probabilities of the three possible values are close to each other. Accordingly, although the score derived in both cases is the same (“70”), the estimation about the accuracy of that assessment may be higher in the case shown in Table 1 than in the case shown in Table 2.

Referring again to FIG. 1, upon each interaction of a student with a task, relevant performance metrics are collected and logged by system 100, e.g., by a logger module 178. The logged information includes, for example, correctness of the answer, number of attempts it took the student to reach the answer, time spent on the task, help or hint used for solving the task, or the like. The logged information may be stored in a repository and may be transferred periodically to the CAA sub-system 170. The CAA sub-system 170 utilizes the logged information for estimation of hidden variables in the PBN 183 (e.g., by the CAA engine 177), as well as for generation of reports (by reporting module 176) and alerts (by alerts module 175).

In some embodiments, optionally, the CAA sub-system 170 may include a module for mapping of imported assessment information, for example, to allow mapping of the imported data or of “manual” assessment data (e.g., teacher's observations) with the concepts of the ontology 171, thereby making this assessment information recognized by the CAA sub-system 170 and added to the student's gained knowledge map.

The generated reports may include, for example: a report indicating the number of students who answered all questions associated with a certain knowledge component; a report indicating the number of students who succeeded in first trial in all questions associated with one or more knowledge components; a report indicating distribution of number of trials it took to perform all questions of type “multiple choice” dealing with a certain knowledge component; or the like.

The generated alerts may include, for example: an alert about an identified discrepancy between a group level and activity level (e.g., a certain percent of students in a group failed a certain activity); an alert indicating that a particular student tales too long to complete a task (e.g., compared to his prior performance, or compared to her class or group); or the like.

Accordingly, some embodiments may utilize a flow in which, for example, a student performs a task; then, task-relevant data is logged and stored in a repository, and is periodically transferred to the CAA sub-system 170; and based on the logged information, reports and alerts are generated.

In some embodiments, the student model 183 may provide a statistical validated means of assessing students' level of understanding in different knowledge components. The outputs of the CAA engine 177 may be used for various purposes, for example: as a Student assessment tool used by teacher, providing information to the teacher related to students' achievements; monitoring students' progress in their level of understanding of different assessed variables; alerting the teacher on students' irregular scores compared to the class or the students themselves; or the like. In some embodiments, the CAA engine 177 may provide scores per student, whereas the CAA sub-system 170 may aggregate this information to provide analysis at group or class level.

In some embodiments, the CAA engine 170 may further provide, for example, a self-assessment tool for students, e.g., by displaying appropriate graphs within a tailored student dashboard. In some embodiments, the CAA engine 170 may be used as internal tool for validating content quality; for example, the CAA engine 177 may be used to validate content difficulty level, contribution to different capabilities and effectiveness of this contribution. For example, if a particular question is classified as contributing to a certain capability, yet it consistently appears not to do so among the students, it may be concluded that the question may not actually be contributing to the capability as originally thought. The CAA engine 170 may further be used for diagnosis and adaptive learning; for example, based on the scores provided by the CAA engine 177, students weaknesses may be detected, and tasks may be assigned addressing these weaknesses accordingly.

Some embodiments may allow, for example, enhancing of traditional, manual, assessment process; gaining efficiency, speed and reliability by scanning of tests, computer-based grading, and automatic result summary; accurate and frequent assessment with minimal teachers effort (e.g., closed-form tests and questionnaires are presented and filled on the computer screen, then checked and reported by the computer); formative or adaptive assessment, namely, learning and assessment environments that support different personalized learning environment, materials, style of teaching and learning, progress and schedule for each individual, thereby matching dynamically student's strengths, weaknesses, and state of knowledge.

In some embodiments, system 100 may be used in conjunction with a learning modeling framework including three components: knowledge domains (e.g., all learning objects within the system, and how they relate to each other and to the curriculum demands), narrative model (e.g., the ways the content may be sequenced and presented to students), and student knowledge states (e.g., the state of knowledge of the student in reference to the knowledge space and the narrative model).

In some embodiments, system 100 provides integrated ongoing assessment, for example, based on the student's actual knowledge assessed in view of the required or desired knowledge, in order to allow adaptive offering of educational content and activities.

In some embodiments, system 100 utilizes the relations among the curriculum (the required knowledge, in view of the ontology concepts or benchmarks), the student (the acquired knowledge), and the learning objects (facilitators), in order to allow CAA for one or more goals, for example, generation of alerts and reports (including progress reports and comparison reports), tracking of progress via the dashboard interface, allocation or assignment of digital learning objects, evaluation of the actual contribution of digital learning objects, and other adaptive learning goals.

In some embodiments, the dashboard interface may allow to present multiple reports on the teacher station 110. For example a “class performance” chart may be presented, showing vertical bars in a chart, in which the vertical axis indicates the number of students per bar, whereas the horizontal axis indicates ranges of correct answers (e.g., showing that 7 students in the class answered correctly between 10 to 15 questions; 9 students in the class answered correctly between 16 to 21 questions; or the like). Additionally or alternatively, a “success in first attempt” chart may be presented, showing vertical bars in a chart, in which the vertical axis indicates the number of students per bar, whereas the horizontal axis indicates ranges of correct answers that were answered correctly in a first attempt (e.g., showing that 7 students in the class answered correctly in their first attempt between 10 to 15 questions; 9 students in the class answered correctly in their first attempt between 16 to 21 questions; or the like).

Additionally or alternatively, a “class performance deviators” chart may be presented, showing vertical bars in a chart, in which the vertical axis indicates the number of questions answered correctly per student, whereas the horizontal axis indicates individual students (for example, identified by names) (e.g., showing that Adam answered correctly 7 out of 10 questions, whereas Bob answered correctly 9 out of 10 questions). Additionally or alternatively, a “planning versus actual progress” diagram may be presented, showing a first progress bar with learning activities planned by the teacher, in which the actually performed learning activities are marked or highlighted (e.g., entirely, or partially); and optionally a second progress bar with learning activities planned by another entity (e.g., school principal, teacher supervisor, Board of Education), in which the actually performed learning activities are marked or highlighted (e.g., entirely, or partially). The progress bar may indicate the current date at a position corresponding to the current progress; as well as past dates (e.g., in positions corresponding to previously achieved progress) and/or future dates (e.g., in positions corresponding to yet-to-be-achieved progress).

In some embodiments, the system may allow generation of graphs or charts showing the number of students who correctly answered particular ranges of correct answers, in particular classes and/or grades, and in particular subjects. For example, a bar chart may correspond to numbers of students who answered correctly 0 to 10 questions versus 11 to 20 questions in a class named “Flower” in the third grade in the subject of “mathematics” in the topic of “multiplication” during weeks 7 to 14 of the school-year.

Although portions of the discussion herein relate, for demonstrative purposes, to generated reports having “bar diagrams”, other suitable types of diagrams or graphical representations may be included in the generated reports. For example, a demonstrative report may include a “pie chart” to represent class performance with regard to a particular question or task: the pie chart may include a first “slice” indicating that 21 percent of the students in the class answered the question correctly in their first attempt, a second “slice” indicating that 47 percent of the students in the class answered the question correctly in their second attempt, and a third “slice” indicating that 32 percent of the students in the class did not answer the question correctly in the two attempts allocated to them. In some embodiments, the teacher may utilize the teacher station 110 and/or the dashboard 174 in order to generate an assortment of reports, using one or more textual styles and/or graphical representation styles of her choice.

In some embodiments, each educational content item (e.g., digital learning objects) is tagged with all the concepts (from the ontology) that it promotes or assists in the learning process. Accordingly, since system 100 tracks and logs all student activities, system 100 is able to determine in which concepts the student did some learning. Then, by adding to the ontology concepts tagging of the digital learning object some parameter-based dependencies (e.g., implementing a PBN), the “gained knowledge” may be automatically measured and mapped.

In some embodiments, the integrated ongoing assessment may contribute to shortening of correction cycles. The interacting components include, for example: the required knowledge map (e.g., ontology concepts describing standards and curriculum set goals), the learning model (e.g., the way(s) the educational content is presented to students), and the knowledge space (e.g., digital learning objects and their tagged relation to ontology concepts). These components interact in a system which includes in-class work, homework, tests, and ongoing monitoring and logging of substantially all students actions, in order to generate and a student's actual knowledge map (e.g., the student's record in reference to the knowledge space and the learning model). This may be used for, e.g., teacher's intervention (if needed), and/or adaptive offering of educational content to the student.

In some embodiments, system 100 may optionally include additional hardware components and/or software components in order to implement the function or operations discussed herein. For example, system 100 may optionally include: a question bank (e.g., standard-based), from which a test and practice generator is able to generate tests and practices; a repository for test results; a repository to store the logged information tracking substantially all off the student interactions with the system and the digital learning objects presented to her; repository to store data and results of assessment events; pedagogic meta-data; a knowledge management environment or other adaptive teaching/learning tools, optionally connected to the ontology or the required knowledge map; Application Programming Interface (API) tools to interact with one or more components of system 100; or the like.

In some embodiments, components of system 100 may interact to allow dynamic generation of CAA products. For example, the ontology of controlled vocabularies (e.g., curricular, pedagogic, behavioral) and the repository of concept-tagged interactive digital learning objects, are the basis for formation of logs based on segment plans (e.g., wherein a segment is a single issue lesson, which may optionally span multiple lessons occurring on multiple days) carried out in class and substantially all students activities (e.g., based in turn on student and teacher actions). The logs are analyzed and compared to the required or desired knowledge map, which in turn is a translation of curricular requirements or standards in view of the ontology. An algorithm analyses the student activities in planned curriculum versus the required or desired knowledge map, talking into account, for example, assessment events, drills and practices using specific tools (e.g., Vocabulary Acquisition Machine (VAM), Practice And Learning (PAL) machine, or other Knowledge Acquisition Machine (KAM)). The analysis results are used by CAA tools, for example, in order to present progress, to allow CAA of a particular student or a group of students or a class, to be used by automated adaptive content generation tools, and to present to the teacher real-time progress (e.g., using the dashboard interface) as well as reports and alerts.

Some embodiments may allow electronic assessment (e-assessment) or CAA, in which information technology is used for assessment-related activity; summative assessment, which takes place after a period of instruction, and is used in order to prove that students gained knowledge over a certain time and/or to compare capabilities of students or student groups; and formative assessment, which is integrated throughout the learning process and in which evidence is used to adapt teaching to meet students' needs. In some embodiments, the CAA is used in conjunction with adaptive learning, in which the system programs itself by adjusting content, weights or strengths for producing the appropriate output, based on automatic flows and/or based on teacher management.

In some embodiments, the CAA sub-system 170 allows for an ongoing assessment process entirely integrated with the learning process and its related activities, continuously comparing students acquired learning outcome to curriculum required learning outcomes. The CAA sub-system 170 may thus provide an ongoing flow of information about the students progress. This may be, for example, in contrast to a testing system which includes a test generator, a scoring system and reporting tools that do not provided an incremental picture of the students progress in the form of summative assessment.

In some embodiments, the CAA sub-system 170 may relate to a variety of indicators of achievement or accomplishment, and not necessarily only to correct or incorrect answers to questions). For example, the CAA sub-system 170 may relate to the time spent on task, repetitions, patterns of behavior, or the like. The CAA sub-system 170 may thus provide more information that is relevant to corrective actions, e.g., in contrast with information provided by a testing system.

In some embodiments, system 100 directly connects or ties the required knowledge with the acquired knowledge, through a wide spectrum of knowledge, capabilities and skill elements that the student is expected to master on his way to obtain the requirements or standards stated for a given learning unit (or for a discipline at a specific age group). This may allow for better or more suitable correction measures, as well as for adaptation of educational content and activities that may help overcome hidden problems that may not be directly deduced from correct or incorrect answers to questions.

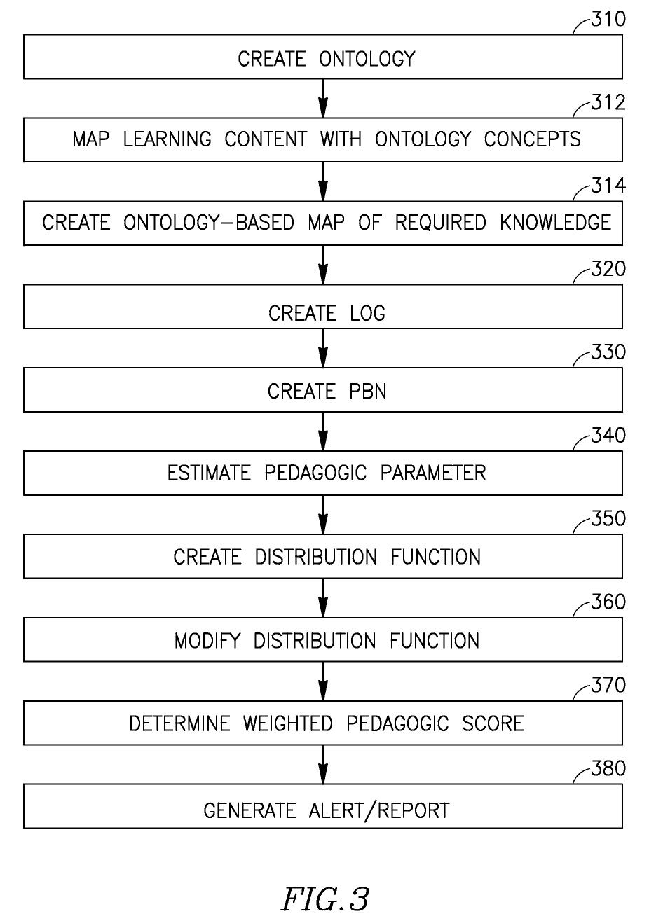

FIG. 3 is schematic flow-chart of a method of Computer-Assisted Assessment (CAA), in accordance with some demonstrative embodiments. Operations of the method may be used, for example, by system 100 of FIG. 1, and/or by other suitable units, devices and/or systems.

In some embodiments, the method may include, for example, creating an ontology of concepts (block 310).

In some embodiments, the method may include, for example, mapping (or tagging) all learning activities and/or learning content elements with the relevant concepts from the ontology (block 312).

In some embodiments, the method may include, for example, creating an ontology-based map of required knowledge (block 314).

In some embodiments, the method may include, for example, creating a log of interactions of a student with digital learning objects, which are concept-tagged based on the ontology (block 320).

In some embodiments, the operation of blocks 310-320 allow creation of meaningful reports that describe a student's accomplishments in relation to what the learning standard and the milestone set for his age or grade require; as well as determination of the gap between the acquired knowledge and the required knowledge, a particular knowledge gap which may base student-adapted correction cycles as well as offering of adaptive educational content.

In some embodiments, the method may include, for example, creating a pedagogic Bayesian network based on the log of interactions and the ontology (block 330). This may include, for example, determining a set of observable pedagogic variables based on observable task performance items reflected in the log of interactions; determining a set of hidden pedagogic variables related to the observable pedagogic variables; and determining dependencies among the hidden pedagogic variables. The hidden pedagogic variables include, for example, pedagogic capabilities that the student is required to have in order to successfully accomplish a particular pedagogic task.

In some embodiments, the method may include, for example, estimating a pedagogic parameter related to the student based on the pedagogic Bayesian network (block 340).

In some embodiments, the method may include, for example, creating a distribution function corresponding to an estimation of the probability of possible values for substantially each one of the hidden pedagogic variables (block 350). In some embodiments, the distribution function has at least three possible values corresponding to a strong value, a medium value, and a weak value, and the sum of the three possible values equals to substantially one. In other embodiments, the distribution function has at least two possible values corresponding to a strong value and a weak value (or to pass/fail, acceptable/inacceptable, sufficient/insufficient), and the sum of the two possible values equals to substantially one. Other numbers of possible values may be used.

In some embodiments, the method may include, for example, based on analysis of newly-received observable task performance items reflected in the log of interactions, modifying at least one of the possible values of the distribution function (block 360).

In some embodiments, the method may include, for example, determining a weighted pedagogic score corresponding to the distribution function, based on the sum of weights of scores corresponding to the possible values (block 370).

In some embodiments, the method may include, for example, generating an alert or report related to an assessed pedagogic parameter in relation to a student, a group of students, or a class of students (block 380).

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution.

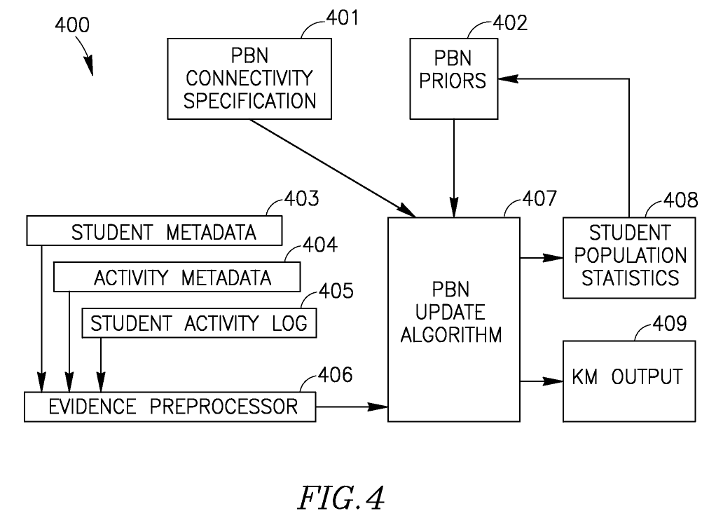

FIG. 4 is a schematic block diagram illustration of a PBN system 400 in accordance with some demonstrative embodiments. The PBN system 400 may include, for example, a PBN connectivity specification 401 and a set of PBN priors 402, which may represent a PBN (namely, a model of the student's state of knowledge within a given subject domain) and may be used as input to a PBN update algorithm 407. Additionally, student metadata 403, activity metadata 404, and student activity log 405, may be used as input to an evidence preprocessor 406, which may output data used by the PBN update algorithm 407. The PBN update algorithm 407 may output student population statistics 408, which may be used to update or modify the PBN priors 402. The PBN update algorithm 407 further generates knowledge map output 409.

The PBN includes a probabilistic model for graphical representation of postulated dependence properties of a set of variables, and the analytical representation of the corresponding probabilities, in a way that facilitates their updating when partial data becomes gradually available. In some embodiments, a Knowledge Network (KN) may describe the PBN used to model the knowledge map for a given subject.

The PBN may be a Directed Acyclic Graph (DAG), in which the connectivity matrix describes the conditional dependence properties of the underlying variables. For example, a variable is conditionally independent of all other variables in the network, given the state of the variables that precede that variable in the PBN (namely, its “parents” ). The PBN connectivity specification 401 may be serialized and stored, for example, using XML description or other suitable format.

The KN may be initialized using an a-priori probability distribution (“prior”). Initially, such PBN priors 402 may be determined based on the experience of domain experts. Once some aggregate data is obtained about the student population, the priors may be refined through estimates of the probability distributions in the population and/or subgroups thereof. In some embodiments, more accurate priors may be set by teachers who have some knowledge about the capabilities of the student, or by the students themselves. The model may be robust to inaccuracy in determining the prior probabilities, as their value is eventually overridden by updates derived from actual student performance. However, setting suitable values as priors may allow faster convergence of the model and earlier attainment of accurate assessment.

Student metadata 403 includes parameters that pertain to the student in general, irrespective of a particular activity, for example, age, mother tongue, known learning disorders, or the like. Activity metadata 404 includes parameters that pertain to a given learning object, irrespective of the way a certain student performs or interacts with this learning object; for example, activity type, level of difficulty, expected completion time, or the like. The student activity log 405 tracks the student's interaction with each learning object, and records the correctness of the student's answer(s) or final answer (for example, “correct” or “incorrect”), the number of attempts made and/or available (e.g., “second attempt out of three available attempts”), the total time to answer (e.g., “14 seconds”), whether or not hint(s) or other assistance were provided to the student, or the like.

The evidence preprocessor 406 analyzes the student metadata 403, the activity metadata 404, and the student activity log 405, and generates a unified evidence score measuring the success of the student in performing the activity. In some embodiments, the formula for computing the unified evidence score may be or may include a heuristic agreed upon by domain and/or pedagogy experts. In other embodiments, particularly once large amounts of data are logged, Machine Learning techniques (e.g., Principal Component Analysis) may be applied directly to this data in order to determine a natural compact representation that retains a maximum amount of information. In still other embodiments, some evidence elements (e.g., knowledge about diagnosed dyslexia) may be inserted as covariates of the PBN model, thereby modifying the assessment of knowledge-map variables.

In some embodiments, the activity metadata 404 specifies, among other things, which variables in the KN affect a given activity. Upon receiving evidence on the performance of an activity, a new node corresponding to this evidence may be added (for example, ad-hoc) to the KN by the PBN update algorithm 407. This node may be connected as a child to the variables that contribute to the respective activity. Then a network update cycle may be performed (for example, by using a message-passing algorithm, e.g., Hugin algorithm on the induced junction tree representation), thereby yielding the posterior probability distribution for the variables in the PBN given the new evidence. At that stage, the ad-hoc addition to the KN may be removed, and the KN may be ready to receive new evidence.

Once the relevant modules are used with a sufficient number of students, the IN states of multiple students may be used to compute population-wide statistics, namely, the student population statistics 408. These may be used to refine the prior probability distribution used to initialize the KN, as well as to improve the generation of simulated student models in order to facilitate research activities.

The state of the PBN may be translated into a set of scores for each of the underlying variables, namely the knowledge map output 409. This can be performed, for example, by assigning numerical values to each of the values that the variables may take (e.g., a score of 40 corresponding to “weak”, a score of 70 corresponding to medium, and a score of 100 corresponding to strong), and then calculating the expectation for each variable.

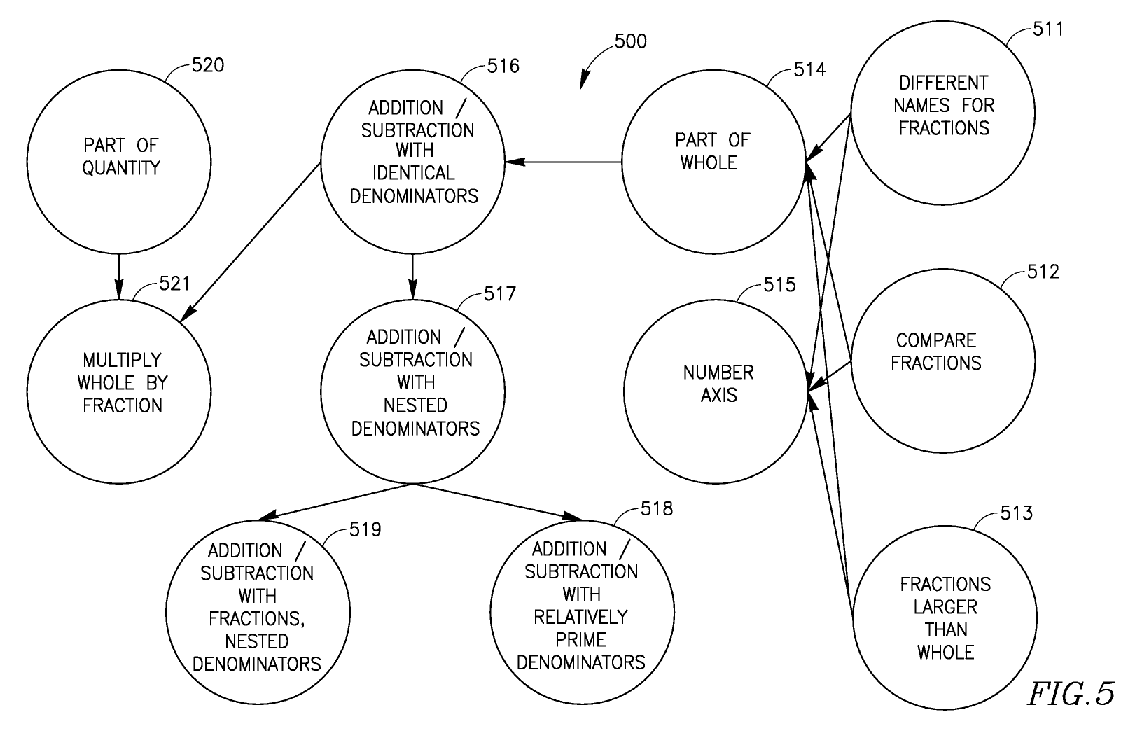

Reference is made to FIG. 5, which is a schematic block diagram illustration of a DAG 500 corresponding to a PBN, in accordance with some embodiments. The DAG 500 may describe the conditional dependence relationships between eleven variables 511-521 assessing the subject matter of “fourth grade fractions”. In some embodiments, a Knowledge Network (KN) may describe the PBN used to model the knowledge map for a given subject.

In some embodiments, a more detailed DAG may be used, in which each one of the eleven variables 511-522 is replaced with a pair of variables: a first variable measuring “knowing” a respective notion, and a second variable measuring “understanding” of that notion. In some embodiments, “knowing” may be defined as a prerequisite to “understanding”, and thus a parent-offspring relationship may always exist between each pair of “knowing”/“understanding” variables.

Each one of the variables 511-521 (or their sub-variables, if each variable is replaced by a pair of knowing/understanding variables) may measure the level at which the student masters the respective concepts. For example, variable 517 may be named “addition and subtraction with nested denominators”, and may actually be represented as two sub-variables (namely, “addition and subtraction with nested denominators—knowing” and “addition and subtraction with nested denominator—understanding”); and the sub-variable “addition and subtraction with nested denominators—understanding” may correspond to “the level at which the student understands addition and subtraction with nested denominators”.

In a demonstrative example, each variable in the PBN may have three possible values, denoted zero, one, and two; which may correspond respectively to “weak”, “medium”, and “strong”. In some embodiments, this scale may be translated into a finer score since the PBN assigns a probability value to each grade in the scale.

Referring back to FIG. 4, the process of eliciting KN structure for a given subject may require cooperation between Machine Learning experts and domain experts. The process may include, for example: defining a proper scope for the subject; breaking down the subject into variables capturing the essential knowledge elements or capabilities; analyzing the conditional dependency between the variables in order to determine the network connectivity matrix; defining prior probability distributions over the network; and defining network priors.

In some embodiments, given KN representations of multiple students, the prior probability distribution may be set through sampling. In the absence of such information, heuristic rules for determining the conditional probability of a child (offspring) node given the values of its parent nodes may be defined (e.g., in coordination with domain experts).

In some embodiments, in order for a student activity to be used as evidence for modifying assessment, each student activity may be related to one or more variables in the KN. The relation may be represented using one or more rules, for example, the following demonstrative rule: performance in activity A is connected to variables V₁ through Vₖ as their “child” (offspring), if, given the values of variables V₁ through Vₖ, the value of A is independent of any other variable in the network.

Other suitable rules or constraints may be used for relating activities to KN variables. For example, within a PBN, “cliques” of interconnected nodes may be identified. For computational efficiency, it may be beneficial not to relate an activity to variables within more than one clique in the network. In some embodiments, the clique structure of the network may coincide with different aspects of the subject; such that if an activity relates to more than one clique, then it may be possible to break the activity down to smaller parts, each part corresponding to a single clique. If this constraint is not met, a possible review and/or modification of the network structure may be required.

Relating activities to KN variables, in accordance with the architectural requirements, may be performed by domain experts who classify the learning materials. Initially, this task may be performed together with a machine learning expert who may assist the domain expert to translate mathematical rules into intuitive understanding of the structure. In some embodiments, a GUI which enforces the architectural constraints on the classification may be used.

Although portions of the discussion herein may relate, for demonstrative purposes, to “simulation” of students or student-related data for purposes of testing of a CAA sub-system or a CAA process, some embodiments may perform and/or utilize such “simulation” for other purposes, for example, as part of a verification routine or validation routine targeted towards verification and/or validation of the knowledge network structure for a given subject or topic.

Some embodiments may simulate student data, for example, in order to allow development and/or testing of a CAA system, or as part of a verification routine or validation routine targeted towards verification and/or validation of the knowledge network structure for a given subject or topic. For example, due to the possible lack of sufficient student activity logs, and in order to test CAA algorithms and/or KNs on large data sets, it may be beneficial to create simulated activity records and initially test the assessment algorithms on the simulated data. Once real-world activity logs become available, they may be used to fine-tune the configuration variables of the student simulator, in order to bring the simulated data closer to the real-world data.

Modeling of students may depend on whether a particular student instance is viewed as having a deterministic value for each variable node in the KN (“deterministic model” or “classical model”), or whether the more accurate description of the student's state is achieved by using a probability distribution for describing the state of each variable (“quantum model”). The two models may be substantially equivalent at the assessment stage, but may differ in terms of student modeling; for example, sampling based on the quantum model may be relatively more complicated, although simplifying assumptions may be used to allow coherent sampling. However, basing student simulation on the quantum model may allow testing of the convergence properties of the network update algorithms on a wider parameter range.

In some embodiments, student simulation may include, for example: defining several student profiles, each characterized by a set of values for all KN variables; then, for each activity in a large activity bank related to the subject, and for each student profile, connecting the activity to the KN in an ad-hoc connection according to the variables it relates to; computing the marginal probability distribution of the activity score (namely, the probability of each possible score for this activity, when performed by a student with the given profile), given the values of its parent nodes; randomly or pseudo-randomly drawing an activity score according to that marginal distribution; and saving the score in the simulated log for the appropriate student profile.

In some embodiments, verifying the validity of CAA results or of KNs may include two aspects: verifying the reliability of the CAA or the KN, namely, the degree to which assessment of a student correctly described by a given KM model would indeed yield the parameters of that model; and verifying the validity of the model, namely, whether the CAA or the KN indeed measures what it is supposed to measure (and in particular, whether a correct model is used to describe a student).

In some embodiments, verifying assessment reliability may be based on assessing controlled, simulated, data; and then comparing the assessment results to the known underlying model. Verifying assessment validity may require an independent (e.g., manual) assessment to be compared to that obtained by the automatic CAA system. Additionally, method(s) may be used to refine the student simulation process, for example, using information about real students and/or through a process of expectation maximization.

With regard to verifying assessment reliability, a process may assume to have a known student model S, where S=<X, G, P>, where X is the set of (random) variables, G is the associated Directed Acyclic Graph (DAG), and P is the set of conditional probability distributions (e.g., one array of conditional distributions for each random variable in X, given the values of its parent variables). The process may assume that from this known model S, a large set of simulated performance observations O was generated, where O={O₁, . . . , Oₖ}, and a PBN was trained based on the same graph, namely, S′=<X, G, P′> using these observations. It may be determined that the assessment algorithms are reliable if the set of probability distributions P′ is close to the generating set P, for many reasonable choices of S, and for values of k (the number of observations) which are in the same order of magnitude as those that may be available in reality.

Accordingly, the process of verifying reliability of a chosen assessment algorithm may include, for example: generating a set of reasonable student models, denoted {S¹, . . . , Sⁿ}. Then, for each student model Sⁱ, doing the following set of operations: generating a set of simulated observations, denoted aⁱ₁, . . . , aⁱₖ; utilizing an ordering criterion to go through the observations; utilizing the chosen algorithm to update the assessment KN based on the observations; and utilizing a chosen metric to measure the distance, denoted dⁱ, between the resulting set of conditional probability distributions Pi′ and the generating set Pi. Then, the process may include verifying that the maximum of {d1, . . . , dn} is sufficiently small.

The ordering criterion for going through the observations may be, for example: a predetermined order, according to a logical syllabus; or a random or pseudo-random order; or an entropy-maximizing order, whereby at each stage the random variable whose estimation carries the greatest information is identified, and an observation relating to this variable is drawn. In some embodiments, the entropy-maximizing ordering may significantly decrease the number of observations required for proper convergence. In some embodiments, the random ordering may be used as a control for the other ordering criteria.

Some embodiments may use a metric for measuring the distance between two distribution sets, namely, a distribution distance metric. For example, instead of defining a metric over a set of conditional probability distributions, the problem is reduced to defining a metric over the set of marginal probability distributions over the same set of variables. In a demonstrative example, each variable has three possible values, and therefore its marginal distribution is given by three numbers summing to one. This, if X={x₁, . . . , xₘ}, then the problem reduces to defining a proper metric d(P,P′), where:

P={(p_{1,1},p_{1,2},p_{1,3}), (p_{2,1},p_{2,2},p_{2,3}), . . . ,(p_{m,1},p_{m,2},p_{m,3})}

and

P′={(p′_{1,1},p′_{1,2},p′_{1,3}), (p′_{2,1},p′_{2,2},p′_{2,3}), . . . , (p′_{m,1},p′_{m,2},p′_{m,3})}

A demonstrative solution is to define:

$$d ( P , {P}^{′} ) = {\sum }_{i}^{ } {c}_{i} \cdot {D}_{ch} ( {p}_{i , 1} , {p}_{i , 2} , {p}_{i , 3} , {p}_{i , 1}^{′} , {p}_{i , 2}^{′} , {p}_{i , 3}^{′} )$$

$$where$$

$${D}_{CH} ( {p}_{i , 1} , {p}_{i , 2} , {p}_{i , 3} , {p}_{i , 1}^{′} , {p}_{i , 2}^{′} , {p}_{i , 3}^{′} ) = \frac{1}{2} {\sum }_{j = 1}^{3} \frac{{( {p}_{i , j} - {p}_{i , j}^{′} )}^{2}}{{p}_{i , j} + {p}_{i , j}^{′}}$$

and (c1, . . . , cm) is by default the unity vector, but it may be adjusted to weigh different variables according to their relative importance. Other suitable equations may be used.

With regard to verifying assessment validity, some embodiments may utilize a process which asks teachers to independently assess student performance according to the same variables used by the KN, and compare the teachers' assessment results to the CAA results. Additionally or alternatively, the validity of the CAA may be verified by testing the accuracy of predicting test results, using the following demonstrative process: given a test measuring certain student capabilities in the subject area (e.g., a standard summative test), break down the test questions into atomic observations (e.g., corresponding to sub-questions); connect the atomic observations to the trained KN via ad-hoc connections to the related variables, and compute the marginal probability distribution for the observation score; draw a random or pseudo-random score for each observation according to its marginal distribution; compute the predicted test score from the constituent atomic observations; repeat the process multiple times to get an empiric estimate for the predicted performance of the student model in this test; and verify the hypothesis that the score, that the student actually got in the test, was drawn from the probability distribution of the trained KN, as estimated empirically.

Some embodiments may include simulation refinement. For example, once the system has data about the performance of real students, the parameters of the student simulation model may be refined, to ensure that the simulated student profiles are as realistic as possible. The system may assume that the student profiles should match some real-world probability distribution, and the target may be to find that distribution based on empirical evidence. This can be achieved through a process of Maximum A Posteriori (MAP) estimation of probability. For example, the Probability Density Function (PDF) for variable v may be described using three numbers (p₁, p₂, p₃=1−p₁−p₂). It may be assumed, for example, that these three parameters are drawn from a Dirichlet distribution with parameters α,β,γ, such that:

$$f ( {p}_{1} , {p}_{2} , {p}_{3} ; α , β , γ ) = \frac{Γ ( α ) Γ ( β ) Γ ( γ )}{Γ ( α + β + γ )} {p}_{1}^{α - 1} {p}_{2}^{β - 1} {p}_{3}^{γ - 1}$$

The process may start from a prior assumption about the values of the three parameters α,β,γ. Then, upon having new evidence about the variable v, an expectation maximization algorithm may be used in order to find the a posteriori distribution given that observation (namely, new values for the parameters α,β,γ). The values of (p1, p2, p3) are changed to the mode of that distribution, namely, to the values which have the highest probability under the a posteriori distribution. The process may be repeated, for example, for each new observation.

Some embodiments may utilize PBNs which take into account the dynamic nature of the learning process. For example, a “classic” BN may assume, implicitly or explicitly, that all observations are drawn from the same set of conditional probability distributions. In contrast, a student in the process of active learning may actually be a dynamic process, in which the underlying probability distributions are continuously changing. Some embodiments may address this, for example, by using a dynamic PBN, such that multiple copies of the PBN are used to represent the underlying model at substantially consecutive time steps or time points, with connections between consecutive steps as well as within the network at substantially each step. Other suitable solutions may used, for example, in order to incorporate to the PBN knowledge about the expected course of learning.

Some embodiments may utilize augmentation of KNs for multiple subjects or across multiple domains. For example, in some embodiments, some practical considerations may require to limit the scope of each KN model to a number of variables which may provide meaningful assessment for a single domain with several closely-related knowledge aspects. However, in some embodiments, possible dependencies may also exist between the knowledge across different domains. Even if each knowledge domain may be assessed independently, taking into account possible dependencies across domains may improve CAA accuracy and/or speed. A possible solution may be, for example, utilization of hierarchical PBNs, such that substantially the entire network describing a given knowledge domain is reduced to a single aggregate variable which may be used when training the networks describing other knowledge domains.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A method of computer-assisted assessment, the method comprising:
creating a pre-defined ontology of pedagogic concepts;
creating a log of interactions of a student with one or more learning activities, wherein the learning activities are concept-tagged based on said ontology;
creating a pedagogic Bayesian network based on said log of interactions and based on said ontology; and
based on said pedagogic Bayesian network, estimating a pedagogic parameter related to said student.

2. The method of claim 1, wherein creating the pedagogic Bayesian network comprises:
determining a set of one or more observable pedagogic variables based on one or more observable task performance items reflected in the log of interactions.

3. The method of claim 2, wherein creating the pedagogic Bayesian network further comprises:
determining a set of one or more hidden pedagogic variables related to said one or more observable pedagogic variables.

4. The method of claim 3, wherein the hidden pedagogic variables comprise one or more pedagogic capabilities that the student is required to have in order to successfully accomplish a particular pedagogic task.

5. The method of claim 3, wherein creating the pedagogic Bayesian network further comprises:
determining one or more dependencies among the one or more hidden pedagogic variables.

6. The method of claim 5, comprising:
creating a set of one or more conditional distribution functions corresponding to an estimation of the probability of possible values for substantially each one of the hidden pedagogic variables.

7. The method of claim 6, wherein the set of one or more conditional distribution functions has at least three possible values corresponding to a strong value, a medium value, and a weak value, and wherein the sum of probability of the three possible values equals to substantially one.

8. The method of claim 6, comprising:
based on analysis of newly-received observable task performance items reflected in the log of interactions, modifying the probability assigned to at least one of the possible values of the set of one or more conditional distribution functions.

9. The method of claim 8, comprising:
determining a weighted pedagogic score corresponding to said set of one or more conditional distribution function, based on the sum of weights of scores corresponding to said possible values.

10. The method of claim 8, comprising:
generating a report indicating pedagogic progress of at least one of: a student, a group of students, and a class of students.

11. The method of claim 8, comprising:
generating an alert indicating a discrepancy between an expected pedagogic parameter of a student and an assessed pedagogic parameter of said student.

12. The method of claim 1, wherein the pedagogic Bayesian network is further based on a teacher input indicating at least one of:
a known strength of said student; and
a known weakness of said student.

13. The method of claim 1, wherein creating the pedagogic Bayesian network is comprised within an algorithm which creates one or more statistically evolving models based on relational concept mapping.

14. The method of claim 1, wherein creating the pedagogic Bayesian network comprises creating a dynamic pedagogic Bayesian network; wherein a plurality of copies of the dynamic pedagogic Bayesian network represent a model of said student at a plurality of interconnected time points; and wherein estimating the pedagogic parameter is based on said dynamic pedagogic Bayesian network.

15. The method of claim 1, wherein creating the pedagogic Bayesian network comprises creating a hierarchical pedagogic Bayesian network including at least one dependency across two pedagogic domains.

16. The method of claim 1, wherein one or more priors of the pedagogic Bayesian network are dynamically modified based on an analysis which takes into account: metadata of said student, metadata of said one or more learning activities, and activity log of said student.

17. The method of claim 1, comprising:
verifying the pedagogic Bayesian network by at least one of:
utilization of controlled simulated student-related data; and
utilization of input from a manual assessment process.

18. A system for adaptive learning and teaching, the system comprising:
a repository to store a pre-defined ontology of pedagogic concepts; and
a computer-aided assessment module to create a log of interactions of a student with one or more learning activities, wherein the learning activities are concept-tagged based on said ontology; to create a pedagogic Bayesian network based on said log of interactions and based on said ontology; and based on said pedagogic Bayesian network, to estimate a pedagogic parameter related to said student.

19. The system of claim 18, wherein the computer-aided assessment module is to determine a set of one or more observable pedagogic variables based on one or more observable task performance items reflected in the log of interactions.

20. The system of claim 19, wherein the computer-aided assessment module is to determine a set of one or more hidden pedagogic variables related to said one or more observable pedagogic variables.

21. The system of claim 20, wherein the hidden pedagogic variables comprise one or more pedagogic capabilities that the student is required to have in order to successfully accomplish a particular pedagogic task.

22. The system of claim 20, wherein the computer-aided assessment module is to determine one or more dependencies among the one or more hidden pedagogic variables.

23. The system of claim 22, wherein the computer-aided assessment module is to create a set of one or more conditional distribution functions corresponding to an estimation of the probability of possible values for substantially each one of the hidden pedagogic variables.

24. The system of claim 23, wherein the set of one or more conditional distribution functions has at least three possible values corresponding to a strong value, a medium value, and a weak value, and wherein the sum of the probabilities of the three possible values equals to substantially one.

25. The system of claim 23, wherein, based on analysis of newly-received observable task performance items reflected in the log of interactions, the computer-aided assessment module is to modify at least one of the probabilities of the possible values of the set of one or more conditional distribution functions.

26. The system of claim 25, wherein the computer-aided assessment module is to determine a weighted pedagogic score corresponding to said set of one or more conditional distribution functions, based on the sum of weights of scores corresponding to said possible values.

27. The system of claim 25, comprising:
a report generator to generate a report indicating pedagogic progress of at least one of: a student, a group of students, and a class of students.

28. The system of claim 25, comprising:
an alert generator to generate an alert indicating a discrepancy between an expected pedagogic parameter of a student and an assessed pedagogic parameter of said student.

29. The system of claim 18, wherein the pedagogic Bayesian network is further based on a teacher input indicating at least one of:
a known strength of said student; and
a known weakness of said student.

30. The system of claim 18, wherein the computer-aided assessment module is to create the pedagogic Bayesian network in conjunction with an algorithm which creates one or more statistically evolving models based on relational concept mapping.

31. The system of claim 18, wherein the computer-aided assessment module is to create a dynamic pedagogic Bayesian network; wherein a plurality of copies of the dynamic pedagogic Bayesian network represent a model of said student at a plurality of interconnected time points; and wherein the computer-aided assessment module is to estimate the pedagogic parameter based on said dynamic pedagogic Bayesian network.

32. The system of claim 18, wherein the computer-aided assessment module is to create a hierarchical pedagogic Bayesian network including at least one dependency across two pedagogic domains.

33. The system of claim 18, wherein the computer-aided assessment module is to dynamically modify one or more priors of the pedagogic Bayesian network based on an analysis which takes into account: metadata of said student, metadata of said one or more learning activities, and activity log of said student.

34. The system of claim 18, wherein the computer-aided assessment module is to verify the pedagogic Bayesian network by at least one of: utilization of controlled simulated student-related data; and utilization of input from a manual assessment process.
